(19) United States
(12) Patent Application Publication
(10) Pub. No.: US 2024/0045885 A1
(43) Pub. Date: Feb. 8, 2024

(54) DIRECT ACCESS METHOD OF BYPASSING PARTITION OVERHEAD IN MASSIVELY PARALLEL PROCESSING (MPP) ENVIRONMENT

(71) Applicant: INTERNATIONAL BUSINESS MACHINES CORPORATION, ARMONK, NY (US)

(72) Inventors: Yue Li, Beijing (CN); Peng Hui Jiang, Beijing (CN); He Fang Zhang, Beijing (CN); Yang Qu, Beijing (CN); Ming Gao, Beijing (CN); Hai Long Shi, Beijing (CN)

(21) Appl. No.: 17/817,804

(22) Filed: Aug. 5, 2022

(51) Int. Cl. G06F 16/27; G06F 16/2455; G06F 16/2453

(52) U.S. Cl. CPC G06F 16/278; G06F 16/24554; G06F 16/24532; G06F 16/24537

(57) ABSTRACT

A method, computer program product, and computer system are provided. Based on an insert/update/delete (IUD) feature being enabled, and based on receiving an IUD request at a massively parallel processing (MPP) database management system (DBMS) engine, identifying a partition optimized for the IUD request. A partition map is loaded corresponding to a partition optimized for only IUD requests. Based on the IUD request being an insert row operation, a new distribution key is calculated by hash. A new partition map is generated, the insert row operation is executed using the new partition map.

### BACKGROUND

The present invention relates to computer systems, and more specifically to improved performance in MPP database management systems (DBMS).

The MPP DBMS is organized to optimize response in query operations, as in a data warehouse. Generally, the MPP DBMS is not suitable for Insert/Update/Delete (IUD) operations, because such operation require that the MPP DBMS control node evaluate to which partition the operation should be directed. This negatively impacts performance because of the increased network traffic as the IUD operations are transferred among the MPP DBMS partitions. It would be advantageous to allow IUD operations on an MPP DBMS without creating a network bottleneck and impacting performance for both IUD and MPP query operations.

### SUMMARY

A method is provided. Based on an insert/update/delete (IUD) feature being enabled, and based on receiving an IUD request at a massively parallel processing (MPP) database management system (DBMS) engine, identifying a partition optimized for the IUD request. A partition map is loaded corresponding to a partition optimized for only IUD requests. Based on the IUD request being an insert row operation, a new distribution key is calculated by hash. A new partition map is generated, the insert row operation is executed using the new partition map.

Embodiments are further directed to computer systems and computer program products having substantially the same features as the above-described computer-implemented method.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates the operating environment of an MPP DBMS, according to an embodiment of the present invention;

FIG. 2 illustrates an MPP DBMS having multiple partition groups, in accordance with one or more aspects of the present invention;

FIG. 3 illustrates an exemplary partition map;

FIG. 4 illustrates a flow chart of an IUD operation in an MPP DBMS, in accordance with one or more aspects of the present invention;

FIG. 5 illustrates an MPP DBMS scale out addition of a partition;

FIG. 6 illustrates a flow chart of a scale out addition of a partition on an MPP DBMS, in accordance with one or more aspects of the present invention;

FIG. 7 illustrates an MPP DBMS after a partition failover; and

FIG. 8 illustrates a flow chart of a partition failover on an MPP DBMS, in accordance with one or more aspects of the present invention.

### DETAILED DESCRIPTION

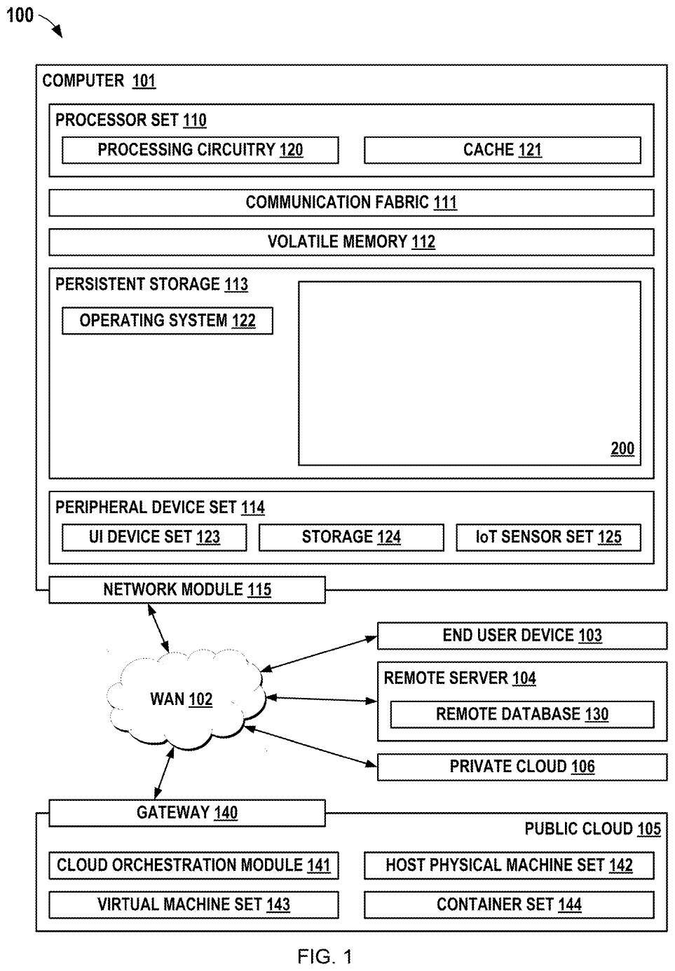

In general, in an MPP DBMS, the data is partitioned across multiple servers or nodes (Computer 101 of FIG. 1), with each server/node having its own memory (Volatile memory 112 of FIG. 1) and/or processors (Processor Set 110 of FIG. 1) to process data locally. Communication is through a network interconnect, such as Communication Fabric 111 and/or Network Module 115, both of FIG. 1. This architecture can be referred to as “shared nothing.” Since each node has its own memory, processors and data storage, there is no single point of contention across the system. For scalability, nodes can be added, in which case each one contributes its own resources.

The MPP DBMS architecture includes a control node and multiple compute nodes. The control node, which is the connection point for external clients, receives one or more requests from the external clients. After analyzing the requests, the control node sends them to the compute nodes for execution. The control node receives the results from the compute nodes, and forwards the results back to the external client.

The control node uses an internally generated partition map, based on a distribution key, to know where to find the data to satisfy the requests. The distribution key is a column, or group of columns, that the control node uses to determine in which database partition, i.e., compute node, a particular data row is stored. For example, if a distribution key is an integer, the distribution key can be hashed to a number between “0” and “32,767”. That number is used as an index into the partition map to select the database partition for that row.

Query performance on the MPP DBMS is generally superior to when the MPP DBMS is used for Insert/Update/Delete (IUD) operations. This is because the partition map, once created, is static and is used for reference. However, for each IUD operation, the control node calculates a new hash value for each new distribution key for each of the row(s) in the operation, resulting in new partition maps. The IUD SQL statement is routed to the appropriate partition for execution. Additionally, numerous IUD operations can result in highly skewed data distributions in the partitions. This can result in network bottlenecks to certain compute nodes and reduced traffic to others. In some cases, the MPP DBMS may implement rebalancing rules and automatic triggers that will execute to redistribute the data in the partitions, thereby increasing network traffic and decreasing performance.

In some environments where embodiments of the present invention are not being practiced, the enterprise may determine to accept the performance degradation, based on a comprehensive evaluation of business factors. However, the enterprise may install both an MPP DBMS dedicated to query operations, and a non-partitioned DBMS for IUD operations. While this may address the performance question, administrative overhead increases, and licensing and hardware costs increase for the duplicate environment.

Embodiments of the present invention address the described issues and shortcomings by allowing the same MPP DBMS to execute both query and IUD operations without impacting network performance, and without skewed data distribution.

The corresponding structures, materials, acts, and equivalents of all means or step plus function elements in the claims below are intended to include any structure, material, or act for performing the function in combination with other claimed elements as specifically claimed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Beginning now with, FIG. 1 an illustration of the operating environment of an MPP DBMS is presented, according to an embodiment of the present invention.

Computing environment 100 contains an example of an environment for the execution of at least some of the computer code involved in performing the inventive methods, such as IUD optimization in an MPP DBMS 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

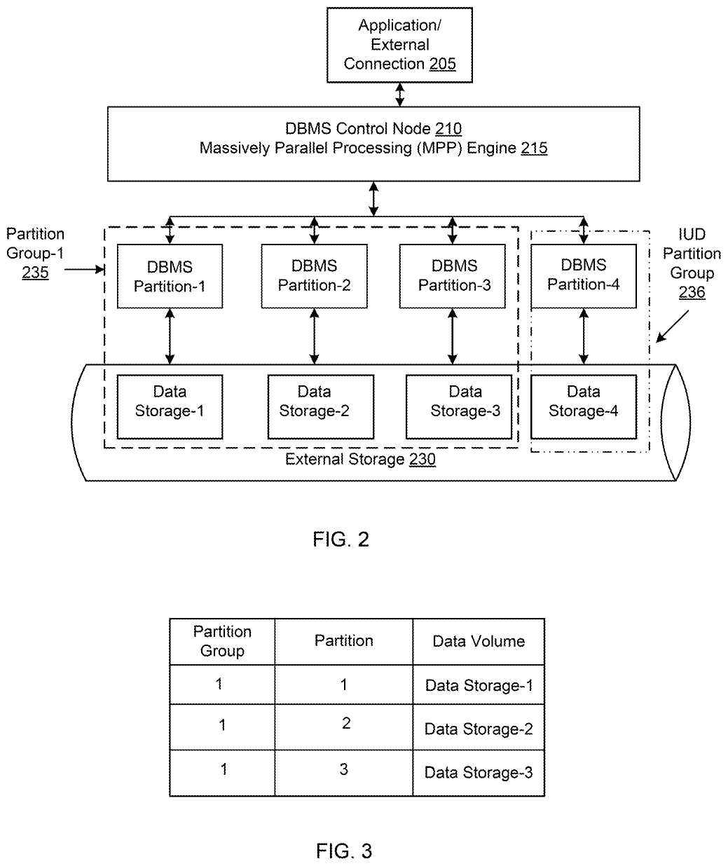

END USER DEVICE (EUD) 103 is any computer system that is used and controlled by an end user (for example, an administrator that operates computer 101), and may take any of the forms discussed above in connection with computer 101. For example, EUD 103 can be the external application by which an end user connects to the control node (200 of FIG. 2) through WAN 102. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

FIG. 2 illustrates an MPP DBMS having multiple partition groups, in accordance with one or more aspects of the present invention.

An external application connection 205 connects to the DBMS control node 210. The DBMS control node 210 hosts the MPP engine 215, which, in the case of a query operation, receives the query request and creates a parallel query plan which is then executed on the compute nodes (DBMS partition-1 through DBMS partition-4). The partitions are grouped into partition groups, based on configuration parameters. In the MPP DBMS architecture, the MPP engine 215 loads and distributes data into partitions based on configuration parameters, such as the distribution key. The distribution can be, for example, by round robin, by random, by hash, by date, or by any other parameter that is meaningful in the context of locating the data. The MPP engine 215 generates a partition map, based on the distribution key and stores it in the system catalog, along with various tables and views that describe the structure of the MPP DBMS. The partition map associates a range of data values for a partition with a particular portion of storage, such as in external storage 230. For example, in partition group-1 235, the data defined to DBMS partition-1 is located in data storage-1, DBMS partition-2 is located in data storage-2, and DBMS partition-3 is located in data storage-3. Although not show, each portion of data storage can include one or more unit, such as a LUN, also referred to as a data volume. Each partition group stores data for one tablespace. In the MPP DBMS architecture, the external storage 230 is typically a storage area network (SAN), or a similar storage architecture.

FIG. 3 illustrates an example partition map to further illustrate partition group-1 235 of FIG. 2. Here, there is only one partition group, partition group “1”, so that each of DBMS partition-1, DBMS partition-2, and DBMS partition-3 is represented in the partition map as belonging to partition group “1”. Additionally, each of the partitions in partition group “1” is given a partition number of “1”, “2”, and “3,” respectively, and is similarly associated with data storage-1, data storage-2, and data storage-3. In FIG. 3, DBMS partition-4 is not associated with partition group “1” and is therefore not defined in the partition map.

In the MPP DBMS architecture, once the data is loaded and the partition map is created, the DBMS engine 215 generates one or more query plans by which the DBMS engine 215 determines which plan is the most efficient for a given query. Because the MPP DBMS environment is architected for rapid query response, the data is static, and so are the query plan(s).

In order to accommodate IUD operations in the same MPP DBMS without impacting query performance, the DBMS engine 215 generates additional, but separate, partition map(s). This allows an IUD operation to be sent directly to the required partition, thereby avoiding regenerating a hash value, and rerouting the IUD operation, thereby avoiding potential network bottlenecks. It has been shown that IUD operations in the MPP DBMS environment account for a majority of network bottlenecks reported to support engineers.

When embodiments of the present invention are installed and enabled, the DBMS engine 215 generates a partition map, based on a configuration-defined distribution key. Each partition corresponds to the portion of the storage in the external storage 230 to which the compute node is attached For example, in FIG. 2 DBMS partition-1 is attached to data storage-1, etc. Here, only IUD partition group 236 is shown as an illustration, although similar IUD partitions are generated for the remaining compute nodes. Additionally, each portion of data storage can include one or more unit, such as a LUN.

Data can be distributed in the IUD partition group 236 according to a configuration defined parameter, as in the MPP partitions, i.e., hash, date, round robin, etc.

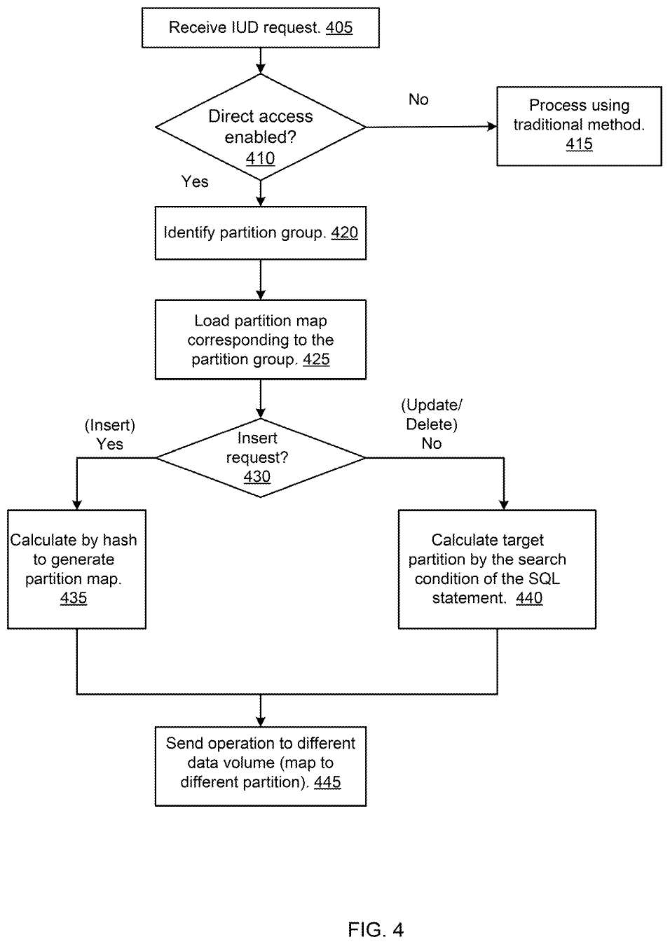

FIG. 4 illustrates a flow chart of an IUD operation in an MPP DBMS, in accordance with one or more aspects of the present invention.

At 405, the DBMS control node 210 receives a request for an IUD operation from the external application connection 205. At 410, the MPP engine 215 checks its product manifest to determine whether IUD optimization feature is installed and enabled. If it is not, at 415 the IUD operation is processed as in a conventional MPP DBMS, i.e., one not having the IUD optimization feature enabled.

If the IUD optimization feature is installed and enabled (410), at 420, the MPP engine 215 identifies the partition group to which the IUD operation is directed.

At 425, the partition map corresponding to the partition group is loaded from the system catalog on the DBMS control node 210.

If the IUD operation is an insert request (430), then at 435 a hash value is calculated for the new value(s). A new partition map is generated since the distribution of the data in the partition is now changed.

At 445, the IUD operation is sent to the data volume in external storage 230 for execution.

If the IUD operation is an update or delete request (430), then the target partition is calculated based on the DBMS optimizer parsing the condition specified in the SQL statement (440), and at 445, the IUD operation is sent to the data volume in external storage 230 for execution.

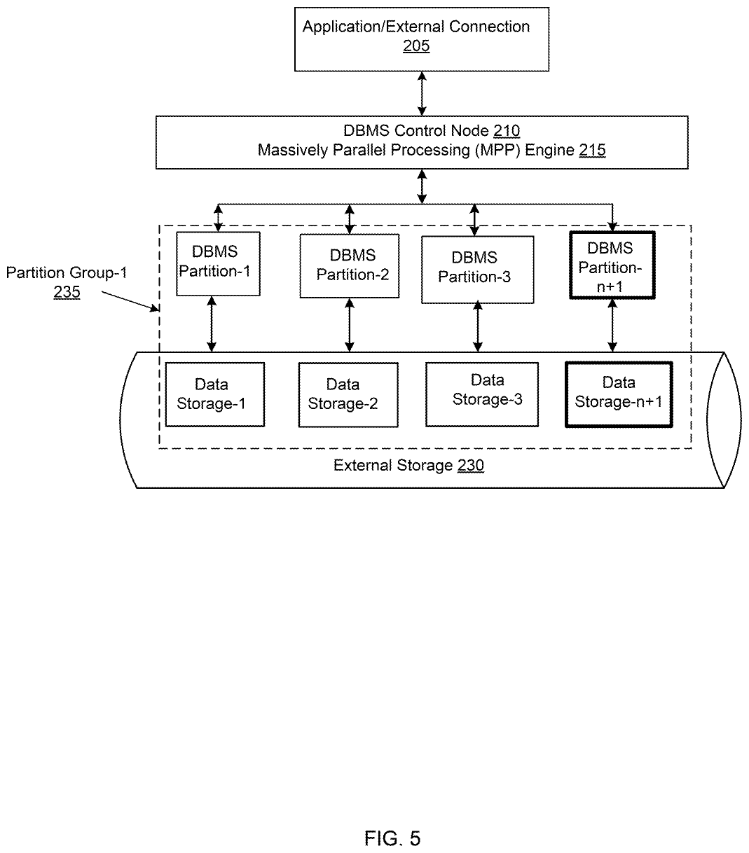

FIG. 5 illustrates an MPP DBMS scale out addition of a partition. Elements having the same label identification as those in FIG. 2 perform substantially the same function. A new partition, DBMS partition-n+1 is added to partition group-1 235. The added partition is associated with data storage-n+1.

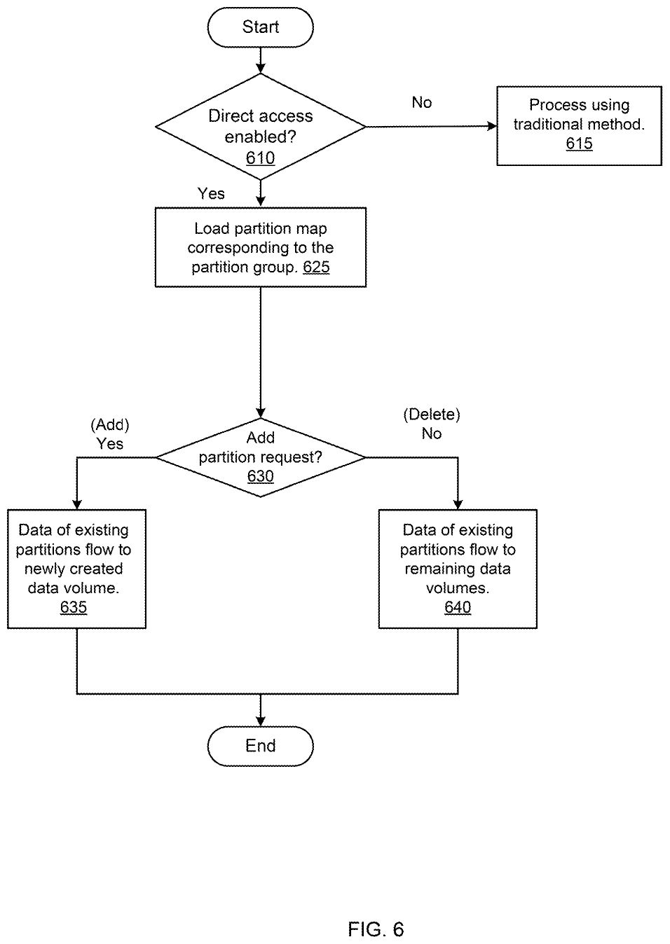

FIG. 6 illustrates a flow chart of the scale out addition of a partition, shown in FIG. 5.

At 610, the MPP engine 215 checks its product manifest to determine whether the IUD optimization feature is installed and enabled. If it is not, at 615 the IUD operation is processed as in a conventional MPP DBMS, i.e., one not having the IUD optimization feature enabled.

If the IUD optimization feature is installed and enabled (610) at 625, the MPP engine 215 loads the partition map corresponding to the partition group.

If the operation is a request to add a partition (630), then a new data volume, data storage-n+1 is allocated to partition group-1 235 from external storage 230. The MPP engine 215 updates its system catalog definition of partition group-1 235 to add DBMS partition-n+1. At 635, the MPP engine 215 then redistributes the data among the partitions, including the new partition. In addition to redistributing the data among the partitions, the MPP engine 215 also updates the distribution key definition for the partition group-1 235 to reflect the new distribution, and updates the new partition map with the new distribution key and distribution. It should be noted that the redistribution occurs at the data volume level, therefore the data movement does not require the network.

If the operation is a request to delete a partition (630), operations to the partition to be removed are stopped, while data on the data storage volume to be deleted is migrated to the remaining data volumes in the partition group. As in the case of the partition addition, the distribution key is updated to reflect the new distribution, and the partition map is updated in the system catalog. Finally, the data storage volume to be deleted is removed from the external storage 230.

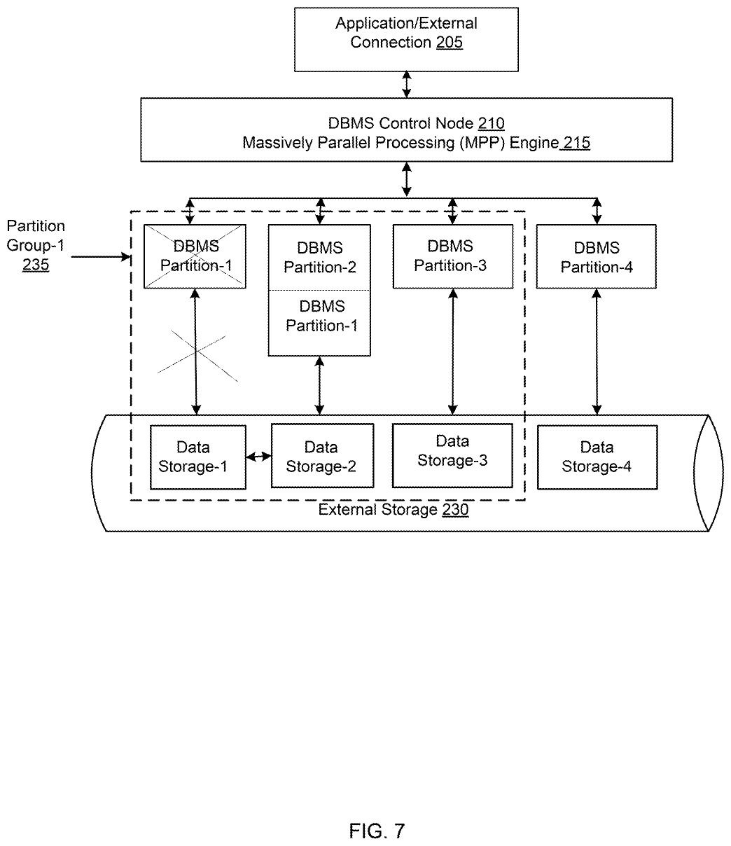

FIG. 7 illustrates an MPP DBMS after a partition failover.

Elements having the same label identification as those in FIG. 2 perform substantially the same function. Here, DBMS partition-1 has failed. Several issues can cause a partition failover, including crash of the compute node, network failure, software failure, and failure of the external storage 230. The partition will be recreated in another partition upon a partition failure. Here, DBMS partition-1 is now accessed through DBMS partition-2. Various conditions are configured in the MPP DBMS and/or operating system that define when a failover occurs. These include, for an example, a timeout parameter before the MPP DBMS engine 215 and/or operating systems recognizes the failover, and a definition of which partition becomes the destination partition upon failover. Requests for data from DBMS partition-1 are now being satisfied by DBMS partition-2. However, different from the scenario of FIG. 5, the data distribution and the partition map are not changed. The location of the data and the retrieval path to the data on data storage-2 are not altered. Although not shown, when the failed DBMS partition-1 recovers, access can be restored.

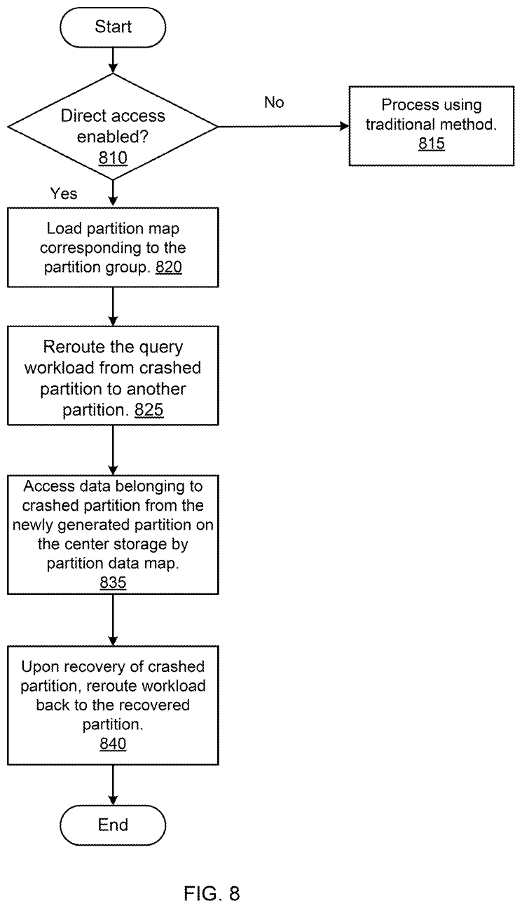

FIG. 8 illustrates a flow chart of a partition failover on an MPP DBMS.

At 810, the MPP engine 215 determines whether the IUD optimization feature is installed and enabled. If it is not, at 815 the failover process is executed as in a conventional MPP DBMS, i.e., one not having the IUD optimization feature enabled.

If the IUD optimization feature is installed and enabled, at 820, the MPP engine 215 recognizes a partition failure condition, and loads the partition map corresponding to the failed partition group. The MPP engine 215 determines which partition takes over data requests for the failed partition.

At 825, the DBMS engine 215 routes the query workload from the failed partition to the recovery partition.

At 835, data that was accessed from the failed partition is now accessed from the newly generated partition using the partition map of the failed partition. No additional network access is needed to route the requests.

At 840, upon recovery of failed partition, reroute workload back to the recovered partition.

1. A method, comprising:
based on an insert/update/delete (IUD) feature being enabled, and based on receiving an IUD request at a massively parallel processing (MPP) database management system (DBMS) engine, identifying a partition optimized for the IUD request;
loading a partition map corresponding to a partition optimized for only IUD requests; and
based on the IUD request being an insert row operation, calculating a distribution key by hash, generating a new partition map, and executing the insert row operation using the new partition map.

2. The method of claim 1, further comprising:
based on the IUD request being other than the insert operation, loading the partition map based on a search condition of the SQL statement.

3. The method of claim 1, wherein the MPP DBMS engine comprises at least one partition optimized for executing only query operations, and at least one partition optimized only for IUD requests.

4. The method of claim 1, wherein a data transfer path for the IUD requests in the MPP DBMS having the IUD feature enabled is changed from network broadcast to single partition direct, thereby reducing network bottleneck.

5. The method of claim 1, wherein the IUD request is directed to a partition optimized for executing only query operations, based on the IUD feature not being enabled.

6. (canceled)

7. The method of claim 1, further comprising:
based on an insert/update/delete (IUD) feature being enabled, loading a partition map corresponding to a partition group having a failed partition;
determining which recovery partition is defined to assume data operations for the failed partition; and
routing data operations from the failed partition through the recovery partition using the partition map of the failed partition.

8. A computer program product, the computer program product comprising a non-transitory tangible storage device having program code embodied therewith, the program code executable by a processor of a computer to perform a method, the method comprising:
based on an insert/update/delete (IUD) feature being enabled, and based on receiving an IUD request at a massively parallel processing (MPP) database management system (DBMS) engine, identifying a partition optimized for the IUD request;
loading a partition map corresponding to a partition optimized for only IUD requests; and
based on the IUD request being an insert row operation, calculating a distribution key by hash, generating a new partition map, and executing the insert row operation using the new partition map.

9. The computer program product of claim 8, further comprising:
based on the IUD request being other than the insert operation, loading the partition map based on a search condition of the SQL statement.

10. The computer program product of claim 8, wherein the MPP DBMS engine comprises at least one partition optimized for executing only query operations, and at least one partition optimized only for IUD requests.

11. The computer program product of claim 8, wherein a data transfer path for the IUD requests in the MPP DBMS having the IUD feature enabled is changed from network broadcast to single partition direct, thereby reducing network bottleneck.

12. The computer program product of claim 8, wherein the IUD request is directed to a partition optimized for executing only query operations, based on the IUD feature not being enabled.

13. (canceled)

14. The computer program product of claim 8, further comprising:
based on an insert/update/delete (IUD) feature being enabled, loading a partition map corresponding to a partition group having a failed partition;
determining which recovery partition is defined to assume data operations for the failed partition; and
routing data operations from the failed partition through the recovery partition using the partition map of the failed partition.

15. A computer system, comprising:
one or more processors;
a memory coupled to at least one of the processors;
a set of computer program instructions stored in the memory and executed by at least one of the processors in order to perform actions of:
based on an insert/update/delete (IUD) feature being enabled, and based on receiving an IUD request at a massively parallel processing (MPP) database management system (DBMS) engine, identifying a partition optimized for the IUD request;
loading a partition map corresponding to a partition optimized for only IUD requests; and
based on the IUD request being an insert row operation, calculating a distribution key by hash, generating a new partition map, and executing the insert row operation using the new partition map.

16. The computer system of claim 15, further comprising:
based on the IUD request being other than the insert operation, loading the partition map based on a search condition of the SQL statement.

17. The computer system of claim 15, wherein the MPP DBMS engine comprises at least one partition optimized for executing only query operations, and at least one partition optimized only for IUD requests.

18. The computer system of claim 15, wherein a data transfer path for the IUD requests in the MPP DBMS having the IUD feature enabled is changed from network broadcast to single partition direct, thereby reducing network bottleneck.

19. The computer system of claim 15, further comprising:
based on an insert/update/delete (IUD) feature being enabled, loading a partition map corresponding to a partition group having a failed partition;
determining which recovery partition is defined to assume data operations for the failed partition; and
routing data operations from the failed partition through the recovery partition using the partition map of the failed partition.

20. (canceled)
